(19) United States
(12) Patent Application Publication
(10) Pub. No.: US 2023/0206334 A1
(43) Pub. Date: Jun. 29, 2023

(54) SYSTEM AND METHOD FOR CREATING A PERSONALIZED RETIREMENT INCOME PLAN

(71) Applicant: Paceit, Inc., Santa Monica, CA (US)

(72) Inventors: Shlomo BENARTZI, Santa Monica, CA (US); Ehud PELEG, Los Angeles, CA (US)

(21) Appl. No.: 18/081,406

(22) Filed: Dec. 14, 2022

Related U.S. Application Data
(60) Provisional application No. 63/294,606, filed on Dec. 29, 2021.

(51) Int. Cl. G06Q 40/06

(52) U.S. Cl. CPC G06Q 40/06

(57) ABSTRACT

A computer-implemented method for generation of personalized income plan for a use, the method includes the steps of obtaining background information about the user, storing the background information in a computer memory, obtaining longevity information from the user via a user interface, storing the longevity information in a computer memory, determining an initial income plan for a user based on the background information and longevity information; determining one or more alternative income plans based on one or more personalized retirement plan options; presenting to a user, via a user interface that implements behavioral economics, the initial income plan and one or more alternative income plans, as choices for selection by the user of one of the income plans, storing the user's selected income plan in a computer memory and displaying a message, via a user interface, based on the user's selected income plan.

### CROSS REFERENCE TO RELATED APPLICATIONS

This application claims priority to U.S. Provisional Patent Application Ser. No. 63/294,606 titled “System And Method For Creating A Personalized Retirement Income Plan”, filed Dec. 29, 2021, the disclosure of which is incorporated by reference herein in its entirety.

### FIELD

This disclosure relates generally to the field of personalized financial planning for retirement. More specifically, it relates to a system and method for creating a personalized retirement income plan. The system and method implement behavioral economics, including presenting a user with choices provided as informed tradeoffs, to obtain information from a user. Based on the user's choices, the system can create a personalized retirement income plan that provides the user with confidence that they will not outlive their retirement savings.

### BACKGROUND

Despite the fact that people today generally live longer and save less, many people seek to retire as early as possible. People seeking to retire are concerned that they will run out of money in retirement and outlive their savings.

Financial service companies, such as, but not limited to retirement plan savings providers, offer to help people save money for retirement, but do not focus on developing income plans for the person during retirement. In addition, financial service companies often lose business when a person retires and withdraws their savings because they do not offer adequate plans for retirees that allows the financial services company to retain those assets.

Current solutions for developing an income plan for retirement are inadequate and have drawbacks. For example, hiring a financial advisor makes sense only for high-net-worth individuals. On the other hand, using a “do it yourself” approach to create a plan is not ideal for such a complex financial problem. Purchasing an annuity may provide some level of payment certainty, but if an individual buys an annuity, they lose control and liquidity of certain assets.

The system and methods described herein provide advantages to plan participants as well as to retirement plan savings providers.

### SUMMARY

One aspect of the invention includes a computer-implemented method for generation of personalized income plan for a user. The computer-implemented method includes the steps of obtaining background information about the user, storing the background information in a computer memory, obtaining longevity information from the user via a user interface, storing the longevity information in a computer memory, determining an initial income plan for a user based on the background information and longevity information; determining one or more alternative income plans based on one or more personalized retirement plan options; presenting to a user, via a user interface that implements behavioral economics, the initial income plan and one or more alternative income plans, as choices for selection by the user of one of the income plans, storing the user's selected income plan in a computer memory and displaying a message, via a user interface, based on the user's selected income plan.

Another aspect includes the step of presenting to a user, via a second user interface that implements behavioral economics, the income plan and one or more alternative updated income plans, as additional choices for selection by the user of one of the income plans as an updated income plan and storing the user's selected updated income plan in a computer memory.

Yet another aspect of the user interface includes presenting the user with choices of income plans based on different retirement dates, different levels of risk of outliving retirement savings, different amounts the user wants to bequeath after their death, different choices of income plans with different spending slopes, different income plans with different holiday spending allowances and/or different income plans with different travel spending allowances.

In yet other aspects, the behavioral economics technique implemented by the user interface to present choices to the user uses the technique of middle bias or infographics.

A personalized income plan determination system, comprises a plurality of first data storage devices maintaining information about a user; a financial engine computing device in communication with the first plurality of data storage devices, the financial engine computing device operative to calculate retirement payment plan options for a user based on a user's choices; and a personalization computing device in communication with the financial engine for creating and transmitting one or more user interfaces that implement behavioral economics to a user device to present the retirement plan options as informed tradeoffs to the user and to allow the user to make a selection of retirement income plan options, automatically calculate a personalized income plan based on the user's selection and send a message relating to the personalized income plan to a user interface to be displayed to the user.

Other advantages of the present invention will become readily apparent from the following detailed description. The invention is capable of other and different embodiments, and its several details are capable of modifications in various obvious respects, all without departing from the invention. Accordingly, the drawing and description are illustrative in nature, not restrictive.

### BRIEF DESCRIPTION OF THE DRAWINGS

The foregoing aspects and many of the attendant advantages of the disclosed embodiments will become more readily appreciated by reference to the following detailed description, when taken in conjunction with the accompanying drawings, wherein:

FIG. 1 illustrates a block diagram of an example of a computing environment for creating a personalized income plan that provides the user with confidence that they will not outlive their retirement savings.

FIG. 2 illustrates an example user interface for display by the user device.

FIG. 3 illustrates an example user interface for display by the user device.

FIG. 4 illustrates an example user interface for display by the user device.

FIG. 5 illustrates an example user interface for display by the user device.

FIG. 6 illustrates an example user interface for display by the user device.

FIG. 7 illustrates an example user interface for display by the user device.

FIG. 8 illustrates an example user interface for display by the user device.

FIG. 9 illustrates an example user interface for display by the user device.

FIG. 10 illustrates an example user interface for display by the user device.

FIG. 11 illustrates an example user interface for display by the user device.

FIG. 12 illustrates an example user interface for display by the user device.

FIG. 13 illustrates an example user interface for display by the user device

FIG. 14 illustrates an example user interface for display by the user device.

FIG. 15 illustrates an example user interface for display by the user device.

FIG. 16 illustrates an example user interface for display by the user device.

FIG. 17 illustrates an example user interface for display by the user device.

FIG. 18 illustrates an example user interface for display by the user device.

FIG. 19 illustrates an example user interface for display by the user device.

FIGS. 20A, 20B and 20C are flow diagrams illustrating operation of one example of the method implemented by the system.

FIG. 21 illustrates a schematic diagram of the user experience using the system.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details.

An ongoing area of interest in the retirement planning area is how to better customize retirement income plans for individuals. Individuals seek personalized plans that are easy to develop and provide certainty. One example is for retirement savings plan providers who desire to offer every plan participant options for developing such plans and hope to retain the participant's investment account as they draw down on the account during retirement. If the plan provider can offer a personalized income plan where income is distributed to the individual periodically from the retirement account, the financial services provider may be able to retain retirement funds for a longer period of time and may be able to charge fees for helping develop the plan and/or sending distribution or income payments to the retiree.

As described in more detail below, the system and method described herein implements one or more of financial engineering, longevity science and behavioral economics to develop a personalized income plan for retirement. The system and method described herein provide an onboarding process designed to maximize personalization in a minimum amount of time. The participant experience is centered around the most important numbers for creating a personalized income plan.

The system provides a holistic approach to financial engineering. The system provides a dynamic financial engine to account for market, health and preference changes. The system also creates a plan that improves the financial wellness of retirees.

As described in more detail below, the system and method provide personalized longevity modeling for individuals and households. Choices are presented to users in an architecture designed to encourage the user to make smarter decisions and understand the tradeoffs that impact their plan, i.e., the system presents the user with informed tradeoffs from which to make choices to develop their plan. The system uses a personalization component (also called an informed tradeoff engine) as well as visualization techniques to counter innumeracy. The system also allows for personalized spending slopes to boost wellbeing and reduce habituation. The system also allows for regular allowances for large items to assist with budgeting.

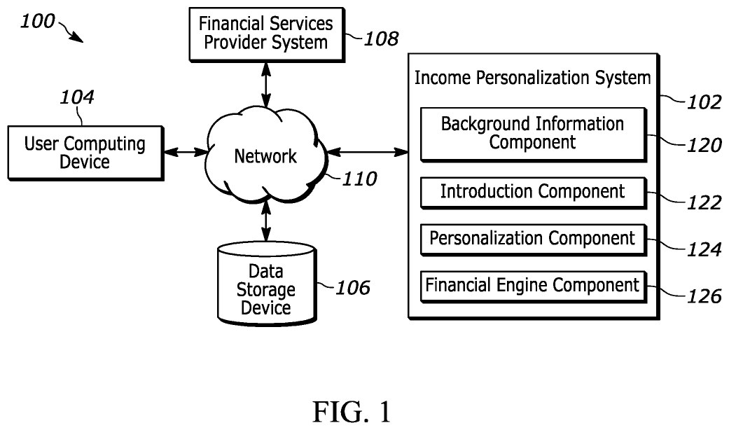

The discussion will now turn to FIG. 1, which is a block diagram illustrating an example of a computing environment 100 for creating a personalized income plan that provides the user with confidence that they will not outlive their retirement savings. The environment 100 includes an income personalization system 102, a user computing device 104, a storage device 106 and a financial services provider system 108. The system 102 and other devices and system are in communication over a network 110.

Embodiments of the income personalization system 102, the user computing device 104 and financial services provider system 108, may be independently selected by any computing device such as desktop computers, laptop computers, mobile phones, tablet computers, server computers, client computers, and the like or by a distributed computing environment including a plurality of computing devices, without limit. Embodiments of the data storage device 106 may include one or more data storage devices capable of maintaining computer-readable data. Examples may include, but are not limited to, magnetic storage (e.g., hard disk drives, etc.), solid state storage (e.g., flash memory, etc.), network storage, and other computer-readable media known in the art. Embodiments of the network 110 may include, but are not limited to, local area networks (LANs), wide area networks (WAN), the Internet, wired networks, wireless networks, and telephone networks.

The income personalization system 102 includes a background information component 120, an introduction component 122, a personalization component 124 and a financial engine component 126. While the income personalization system 102 is illustrated in FIG. 1 as a single device, it may be understood that functionalities of one or more of the components also may be performed by any computing device or by a distributed computing environment including a plurality of computing devices, without limit.

Generally, and as described below in more detail, the background information component 120, the introduction component 122 and personalization component 124 may request and obtain information about the user. They may request various user interfaces from data storage device 106 and send the user interfaces to the user device 104 to request information from the user and/or present information to the user.

Generally, and as described below in more detail, the financial engine component 126 of the income personalization system 102 calculates and determines the retirement income plan, including the amount of each payment to the user upon retirement. The financial engine 126 uses information about the user, typically a retiree or person approaching retirement, including the user's background information, the user's health information and the user's choices with respect to certain tradeoffs in making the calculations. The financial engine component 126 determines and updates the retirement income plan and proposed payments as information is provided from the financial services provider and/or as it is updated by the user and as choices are made by the user, so that the user can see updated estimated payment amounts as information and choices are provided.

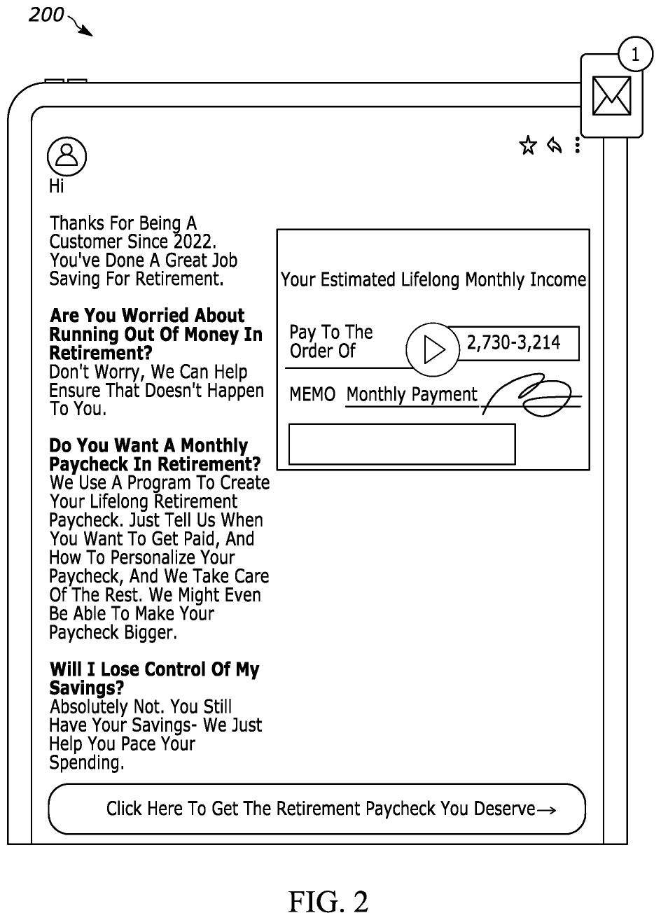

Turning now to FIG. 2, the introduction component 122 of the system may send an introduction user interface 200 to the user computing device 104 for display. The user computing device 104 may display the interface 200 on the user computing device 104. The interface 200 may include a message screen in which a message is displayed to the user along with an initial estimate of lifelong monthly income for the user, based on the user's background information.

As shown in FIG. 2, the interface 200 may provide initial information about an income plan, including an estimate of the range of income that can be generated in retirement before any personalization.

The introduction component 122 may send a series of additional interfaces to the user device to provide additional choices for selection by the user and/or to request additional information from the user.

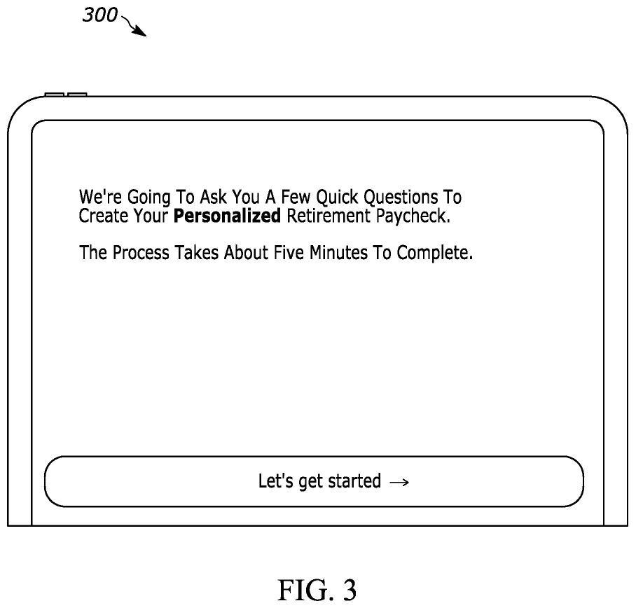

With reference to FIG. 3, the introduction component 122 of the system 102 may send a user interface 300 to the user's computing device 104 for display indicating the estimated time that the process of creating a personalized retirement income plan should take. In the example shown in interface 300, the estimated time is 5 minutes.

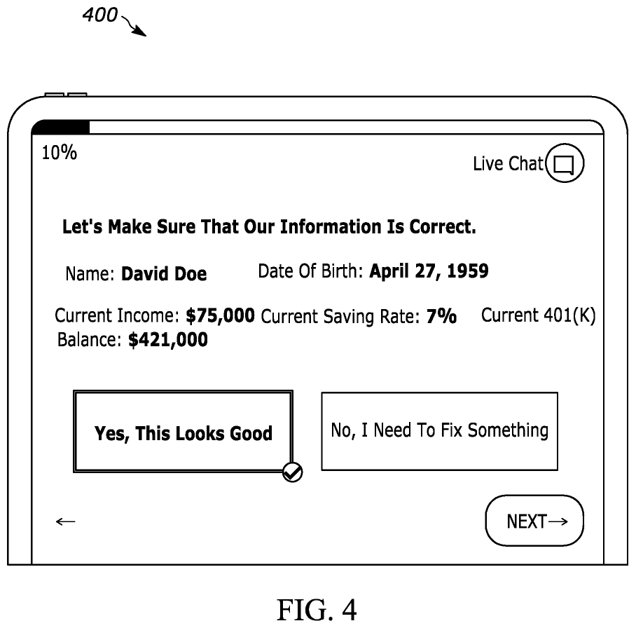

FIG. 4. illustrates another example user interface 400 that may be sent from the introduction component 122 and received and displayed on the user computing device 104. The introduction component 122 of the system 102 may send the user interface 400 to the user's computing device 104 for display and request the user confirm certain background information about the user, such as the user's name, birthdate, current income, current savings rate and current retirement account balance. The interface 400 presents the background information and requests the user make a selection to indicate whether the information is accurate or if it needs to be corrected. If the user indicates anything needs to be corrected, interfaces (not shown) can be sent from the system 102 to the user's device 104 to allow the user to make changes to any of the displayed information. As shown the interface 400 also displays to the user the progress of the personalization process in terms of a percentage completed, i.e., 10% complete. Once the background information is confirmed, other interfaces can be sent to the user's device 104.

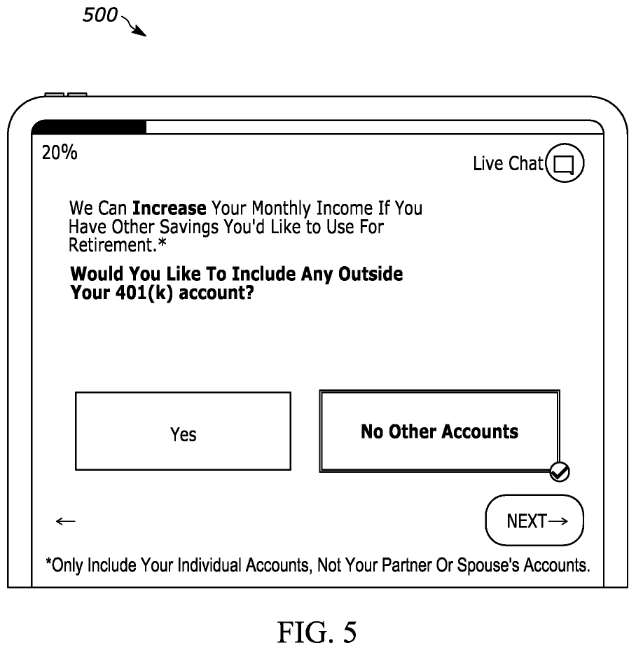

FIG. 5 illustrates another example user interface 500 that may be sent from the introduction component 122 and received and displayed on the user computing device 104. The interface 500 is associated with determining whether the user wants to include any other retirement savings, e.g., savings outside the retirement savings program at the financial services provider. If so, the user is taken to additional interfaces (not shown) to add such information. Once any additional information is provided, other interfaces can be sent to the user's device.

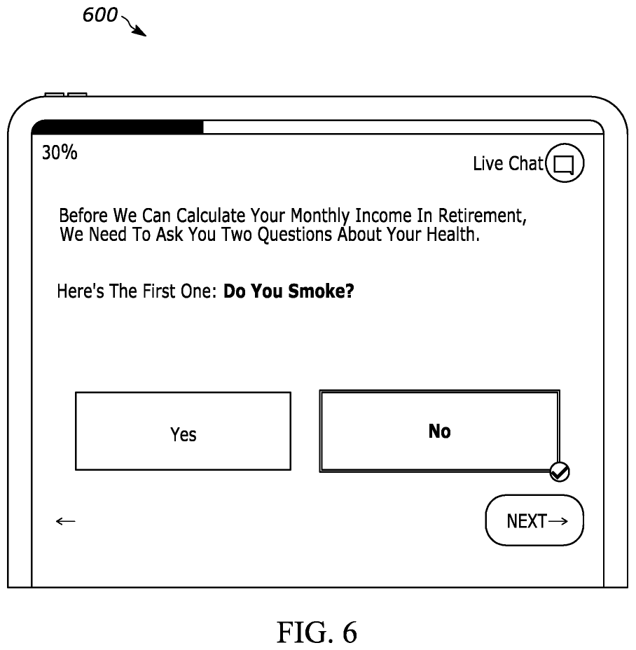

The personalization component 124 of the system may send one or more of a series of interfaces to the user's computing device 104 for display to obtain additional information about the user. As discussed below in more detail with reference to FIGS. 6-18, the personalization component 124 (sometimes referred to as an informed tradeoff engine) may send a number of user interfaces designed using behavioral economics, to present users with choices in a way designed to help users make smarter choices. The financial engine component 126 will also use the information provided by the user to update the personalized income plan after certain steps and before additional personalization information is requested.

Personalized longevity modeling may be performed at the individual or at the household level based on targeted health questions. Personalized longevity modeling enables the system to create an income plan that takes into account longevity risk without other input from the user such as asking them how long they think they will live. Examples of personalized longevity modeling questions are presented in example user interfaces shown in FIGS. 6, 7 and 8.

FIG. 6 illustrates an example of a user interface 600 that can be sent to a user computing device 104 to request the user provide information about whether they are a smoker.

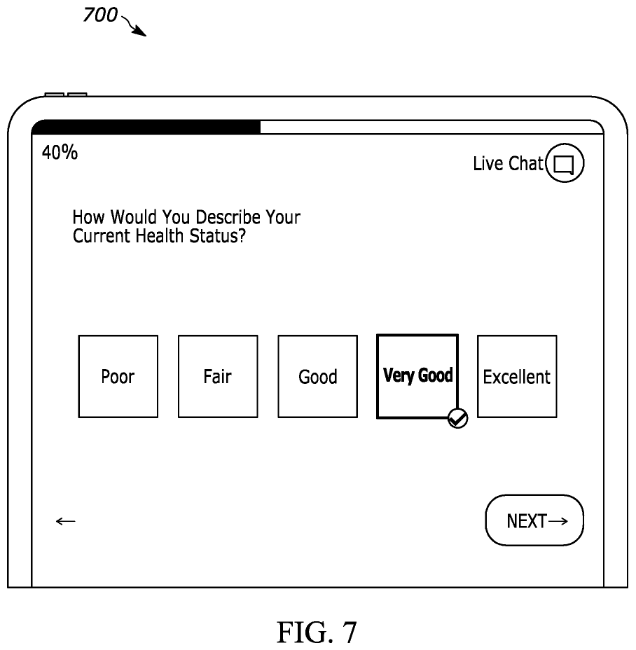

FIG. 7 illustrates an example of a user interface 700 that can be sent to a user computing device 104 to request the user provide subjective information about the user's health.

The information provided in FIGS. 6 and 7 allows the system to adjust standard mortality table to be used by the financial engine to user's health circumstances.

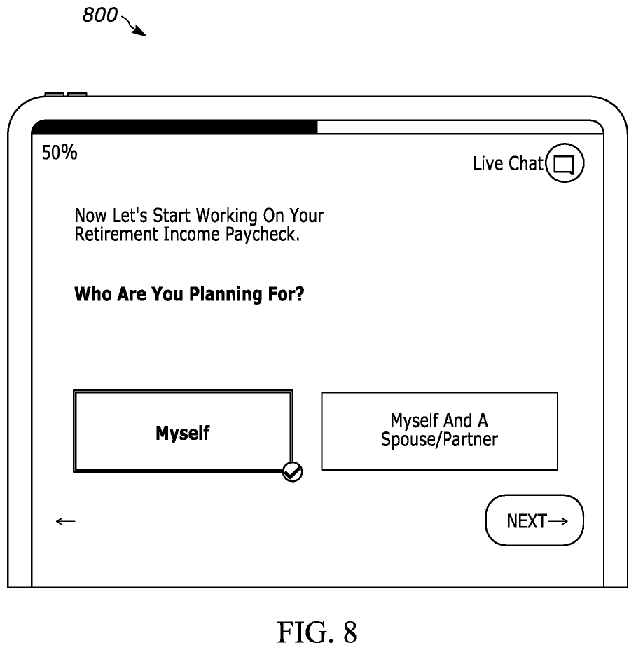

FIG. 8. illustrates another example user interface 800 that may be received and displayed on the user computing device 104. The interface 800 is associated with allowing the user to indicate whether the plan to be created is for the user alone or for the user and another member of the household, such as a spouse or partner. If another member of the household is included, similar questions and user interfaces as shown FIGS. 6 and 7 may be presented about the other member of the household. When planning for a household, the system will also adjust the standard mortality table to use a joint mortality table.

The information collected from the above referenced interfaces (400, 500, 600, 700 and 800) or from other interfaces presented to a user in response to answers to interfaces 400 and 500, may be input into the financial engine component 126 as it is received.

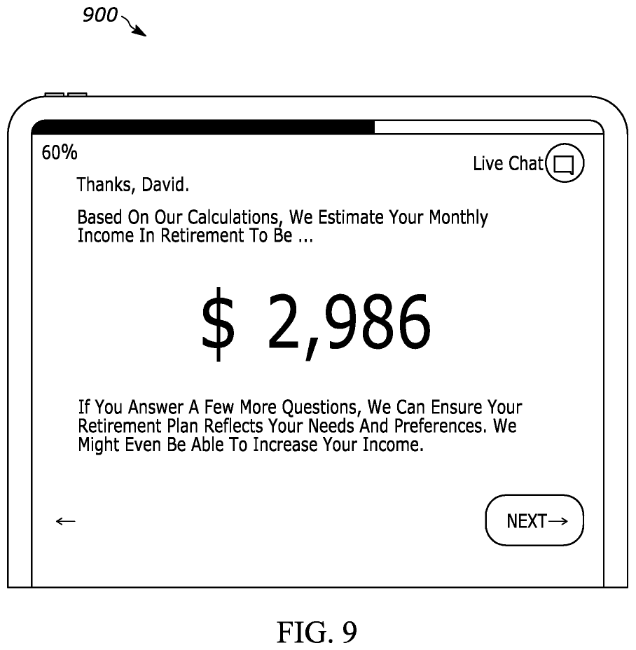

As shown in FIG. 9, the information collected in the above referenced interfaces, e.g., the background information and health information, may be used by the financial engine 126 to calculate an initial estimate of retirement income. The amount of retirement income may be displayed as an estimate of monthly income in interface 900. The interface 900 when presented to the user may use a dynamic representation of the initial monthly estimate, sometimes referred to herein as a “paycheck”, to show the amount starting at $0 and moves to the initial estimate, which, as shown, is $2,986 per month. The speed with which the amount or numbers move may be faster as it starts scrolling and slow as it gets closer to the initial estimate. The dynamic representation of the initial paycheck is designed to engage users by not only showing movement of the numbers, but the deceleration of the numbers as they progress towards the final estimated paycheck amount.

Interface 900 may also indicate that the user can further update the retirement plan if they answer some additional questions for additional personalization not based on the user's longevity.

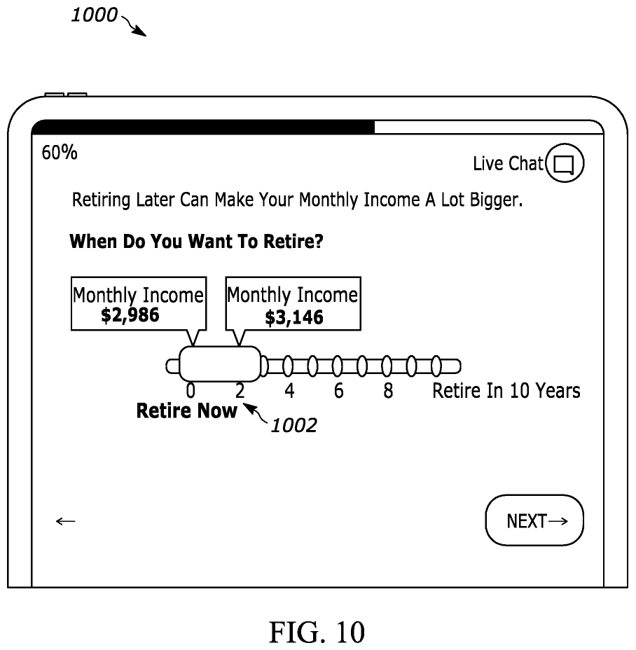

Turning now to FIGS. 10 to 17, a series of other interfaces are shown that use behavioral economics techniques to present the user with choices in the form of informed tradeoffs in order to customize a plan for retirement income. The interfaces may be generated by the personalization component (or tradeoff engine) and/or stored in the data storage device 106. As shown in these user interfaces, informed tradeoffs are presented that illustrate the dollar value of a user's paycheck based on different selections or choices that can be made by the user.

User interfaces described below present choices to users and implement various behavioral economics techniques to display them in a manner to help users make better choices and to be happier with their income plan. For example, for certain choices, the system 102 considers a user's limited cognitive load, and presents a limited number of options for a user to select from, e.g., at most five (5) options for a user to select from. As another example, because people are naturally averse to making choices in terms of tradeoffs, as it requires a high cognitive load, the system 102 makes it easy for a user to assess tradeoffs using visual paycheck images, thus helping the user make choices that reflect their actual preferences.

As yet another example, when asking a user to make especially difficult choices (such as risk) the system 102 may limit the consideration set and present even fewer options for a user to select from, i.e., limit the options for the user to select from to three (3) options. As a further example, a user interface that implements middle bias techniques or that implements infographics may be used to present choices to a user to help them make better choices. Overall, the system 102 implements behavioral economics and allows a user to create a highly personalized income plan tailored to their needs, goals and health.

In addition, the system 102 addresses money illusion bias by illustrating all paychecks in real dollars, not nominal dollars. In other words, the future paychecks illustrated are adjusted for inflation, and do not show nominal dollars.

FIG. 10 illustrates an example user interface 1000 to allow the user to adjust when they retire. The interface 1000 displays a slider 1002 to allow the user to adjust when they will retire. The slider 1002 may be moved or expanded so that it shows as endpoints the earliest year of retirement and the latest year of retirement. As the slider 1002 is moved or expanded by a user, the interface 1000 displays the two (2) times of retirement abounded by the slider (i.e., the earlies year of retirement and the latest year of retirement) and the monthly retirement incomes for those years.

As shown in FIG. 10 the user may select to retire in any of the next ten (10) years. The interface 1000 displays the income that would be available for the selected time of retirement. As shown, the user is informed that if they retired today, the monthly income would be $2,986, but if they retired in two (2) years the income would be $3,146. Thus, the choice, generally, is retire now and have a smaller monthly income or retire later and have a larger monthly income. The financial engine component 126 calculates the different monthly amounts for all ten (10) options so that they can be displayed at the same time and prior to selection by a user to present the choices to the user as informed tradeoffs for selection.

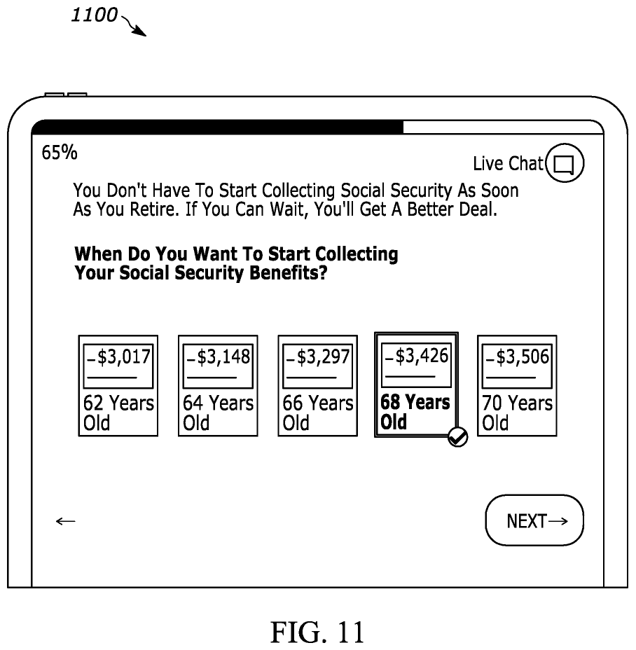

FIG. 11 illustrates an example user interface 1100 to allow the user to adjust when they begin to collect social security benefits. Here, the interface 1100 displays five (5) informed tradeoff choices as options for selection by a user, showing the amount of the monthly payments based on the age at which they start collecting the social security benefits. The financial engine 126 calculates an estimate for starting at each age prior to selection by a user and the estimates are displayed on the screen along with the age to allow the user to make a selection based on choices presented as informed tradeoffs.

Claiming Social Security benefits sooner results in a lower monthly payment and waiting to claim the benefits later results in a greater monthly payment. In this example, the interface 1100 shows a user in a single glance how delaying Social Security may increase their paycheck, thus making it easier for them to select an appropriate claiming age. In addition, the system's financial engine 126 uses a Social Security bridge, drawing down their 401(k) assets first in order to maximize their Social Security benefits.

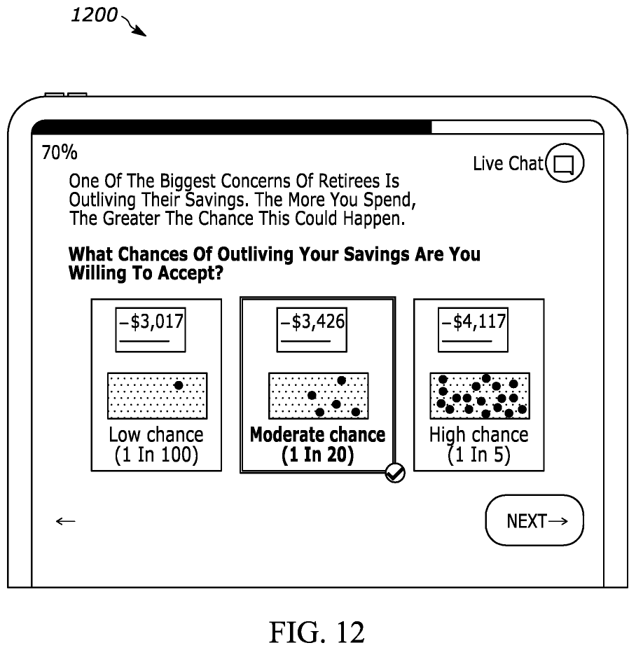

FIG. 12 illustrates an example user interface 1200 to allow the user to select risk in terms of how much of a chance of outliving their retirement income they are willing to accept, i.e., risk selection. The user interface for risk selection 1200 uses middle bias to ensure that the middle option represents a prudent choice for the vast majority of users.

As shown, three (3) choices are provided. Each choice illustrates numerically and using infographic elements, a chance of outliving the savings. The financial engine 126 calculates an estimate for each chance and displays the estimates on the screen to allow the user to make a selection. The choice, generally, is to select less risk in outliving the retirement savings (1 in 100) and have a lower monthly payment or accept more risk of outliving retirement savings (1 in 20 or 1 in 5) and have a greater monthly payment. These choices are presented as informed tradeoffs.

The interface 1200 also utilizes infographic elements to reduce innumeracy when it comes to the understanding of probabilities. The infographic presentation of risk is an important feature and allows a user to visualize the risk. As shown here, along with the payment estimates, the chance of outliving retirement savings is described. In addition, further illustrating the chances, colored pixels may be used with one color (e.g., red) or with one form of shading representing an outcome where the user outlives their savings and another color (e.g., green) or another type of shading or no shading, representing the outcome of the user not outliving their savings. Of course other colors, shading and visualization techniques may be used.

Here, the percent chances are also displayed using the behavioral economics technique of middle bias to encourage the user to make a selection that provides a reasonable amount of certainty. For example, here, the “high chance” (1 in 5) shows significantly more bad outcomes than the “low chance” (1 in 100) or “moderate chance” (1 in 20) illustrations. The “moderate chance” (1 in 20) is the most reasonable and is presented in the middle, i.e., between the “low chance” and “high chance”.

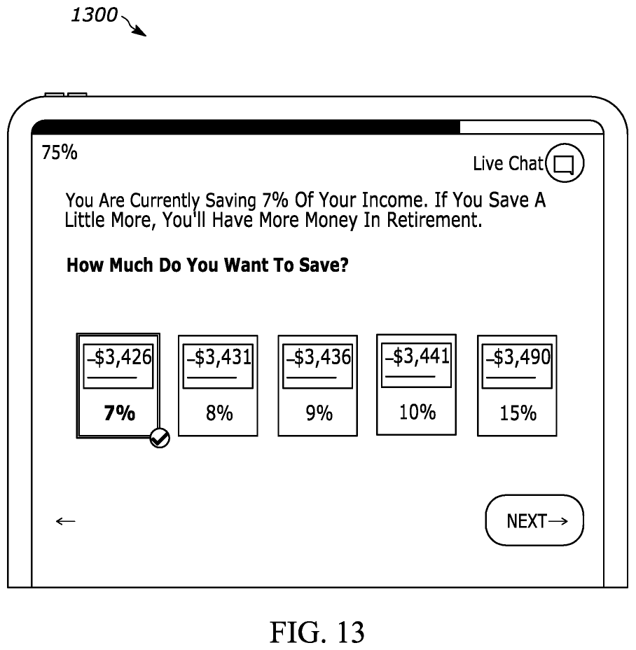

FIG. 13 illustrates an example user interface 1300 to allow the user to select boosting their current retirement savings if they are not already retired. As shown, five (5) informed tradeoffs or choices are provided, starting with the current savings as the lowest amount. The financial engine 126 calculates an estimated monthly payment for each savings rate and the estimates are displayed on the user device 104 to allow the user to make a selection. The choice, generally, is to keep the same savings rate and have a lower monthly payment or boost the savings rate and have a greater monthly payment.

The choices are displayed using the behavioral economics technique of extremeness aversion to encourage a higher savings rate by making prudent choices more palatable for the user. For example, as shown the range of savings rate options are used with the current rate (7%) being on the far left with increasing savings rates as the remaining choices. The last choice (15%) shown on the far right is quite high. The extreme option (e.g., 15%) increases uptake of user selection of a less extreme option (e.g., 10%), which helps people save more. Choosing a less extreme option is also known as a compromise effect.

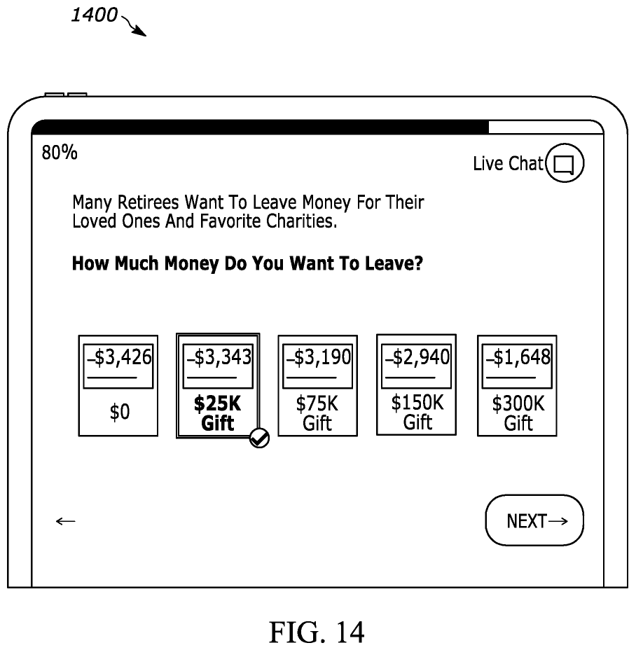

FIG. 14 illustrates an example user interface 1400 to allow the user to decide if they want to leave money for a beneficiary, such as loved ones or charities. As shown, five (5) informed tradeoffs or choices are provided, starting with leaving no money as the lowest amount. The financial engine 126 calculates an estimated monthly payment for each amount to be left to beneficiaries and displays the estimates on the screen to allow the user to make a selection. The choice or tradeoff, generally, is to leave less money to beneficiaries and have a higher monthly payment or leave more money and have a lower monthly payment.

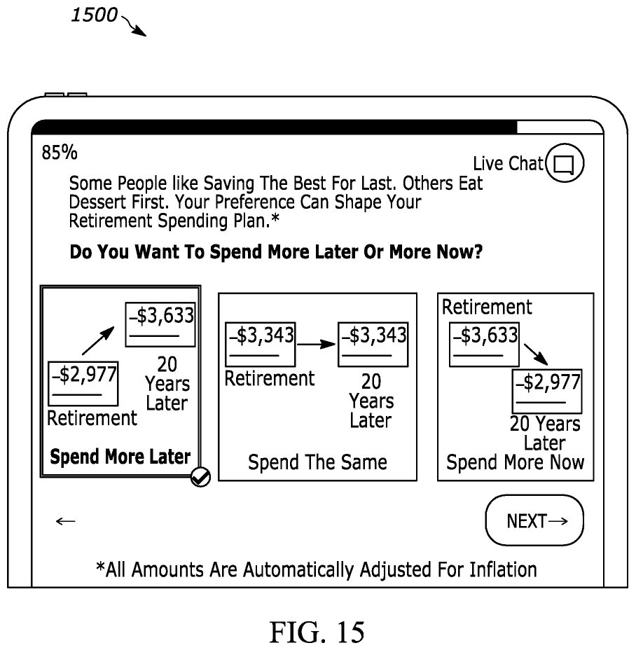

FIG. 15 illustrates an example user interface 1500 to allow the user to personalize their spending slope. Personalized spending slopes can boost wellbeing in retirement. People habituate to levels, but remain sensitive to changes. To minimize habituation, and maximize satisfaction, the system offers users the ability to select an income slope, and thus benefit from the happiness boost that comes from dynamic paychecks over time.

Personalized spending slopes presented by the system may allow a user to decide if they want to have: a lower monthly payment at retirement and a greater payment later, the same monthly payment amount throughout retirement, or a higher monthly payment at retirement and lower one later. The financial engine 126 calculates an estimated monthly payment for each option and displays the estimates on the screen as informed tradeoffs or choices to allow the user to make a selection. As shown in interface 1500, three choices are provided: (1) $2,977 monthly payment at retirement and $3,633 in 20 years (“spend more later”); (2) $3,343 monthly payment throughout retirement (“spend the same”) and (3) $3,633 monthly payment at retirement and $2,977 in 20 years (“spend more now”).

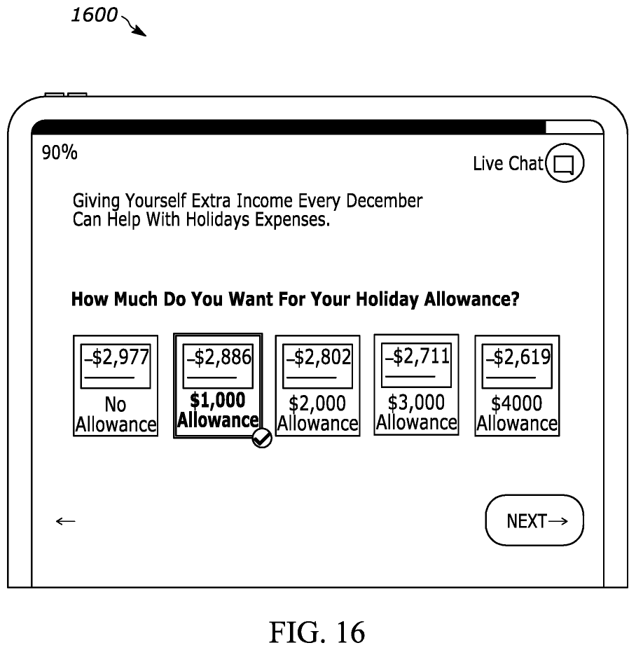

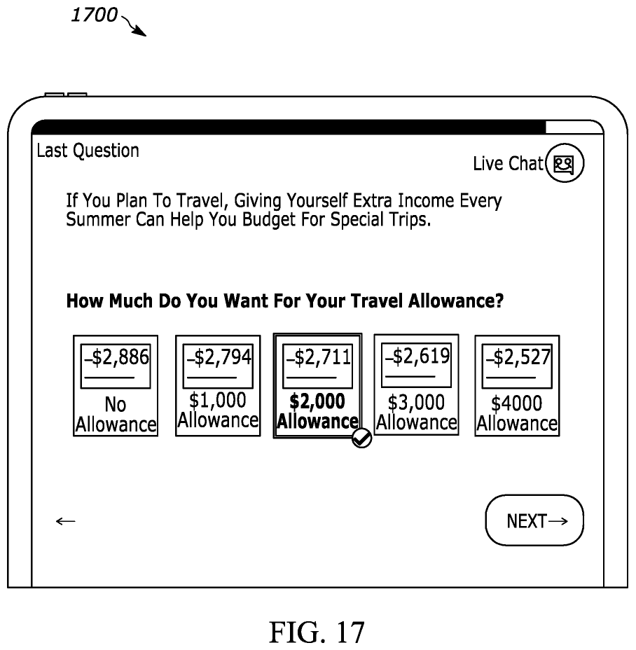

As shown in FIGS. 16 and 17, the system allows personalization for big expenses, such as holiday and travel expenses, to allow people to add in the big expenses they typically spend but don't plan for. Failure to account for such expenses leads to an abandonment of the income plan and budget. Personalizing the plan for such expenses helps create a better income plan as a whole.

FIG. 16 illustrates an example user interface 1600 to allow the user to decide if they want to have an extra allowance for holiday spending. This personalization screen allows a user to budget for infrequent but large expenditures, such as holiday gifting or summer travel. To help people stay on budget, the system offers users allowances that build those expenditures into their overall income plan.

As shown in FIG. 16, five (5) choices are provided, starting with no allowance as the lowest amount presented on the left of the interface, with other choices of $1,000, $2,000, $3,000 or $4,000. The largest amount is presented on the right of the interface. The financial engine calculates an estimated monthly payment for each amount that can be selected as a holiday allowance and displays the estimates on the screen to allow the user to make an informed selection. The choice or tradeoff, generally, is to have less of an allowance and have a higher monthly payment or have a higher allowance and have a lower monthly payment.

FIG. 17 illustrates an example user interface 1700 to allow the user to decide if they want to have an extra allowance for travel spending, with other choices of $1,000, $2,000, $3,000 or $4,000. The largest amount is presented on the right of the interface. The financial engine calculates an estimated monthly payment for each amount that can be selected as a travel allowance and displays the estimates on the screen to allow the user to make an informed selection. The choice or tradeoff, generally, is to have less of an allowance and have a higher monthly payment or have a higher allowance and have a lower monthly payment.

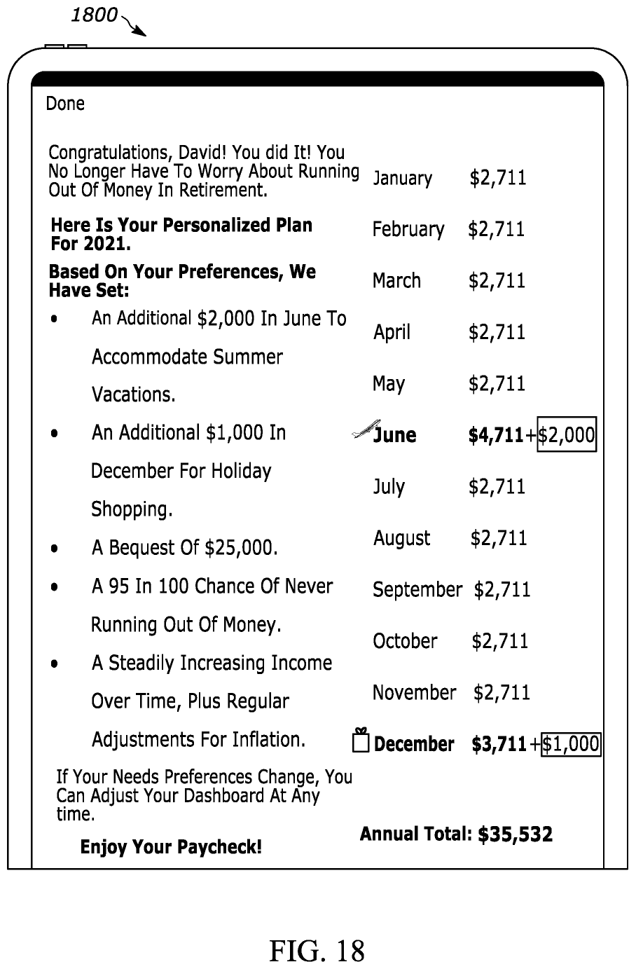

FIG. 18 illustrates an example user interface 1800 that displays a personalized income plan, based on the user's information and choices, which are reflected in the summary paragraphs and bullet points on the left of the user interface 1800. As shown on the right, the personalized monthly paycheck may vary from month to month over a year, to match income and spending, and thus increase the likelihood that a user will remain on budget. For example, as shown, in June the user's monthly paycheck of $2,711 is increased by $2,000 to $4,711 account for personalized travel expenses of $2,000 and in December the monthly paycheck of $2,711 is increased $1,000 to $3,711 account for personalized holiday expenses of $1,000. The total annual income is also shown at $35,532.

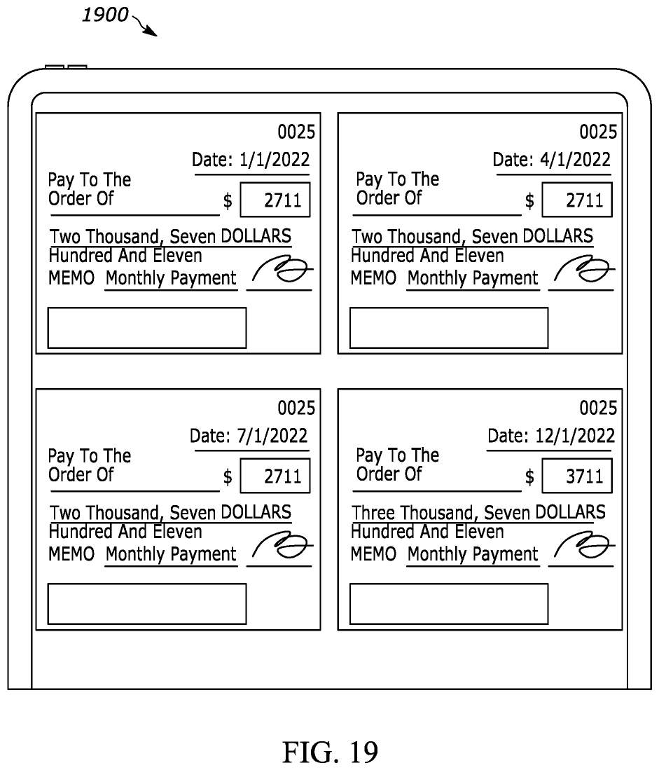

FIG. 19 illustrates an example user interface 1900 that illustrates an income plan based on all of the user's information and choices, with amounts illustrated as checks.

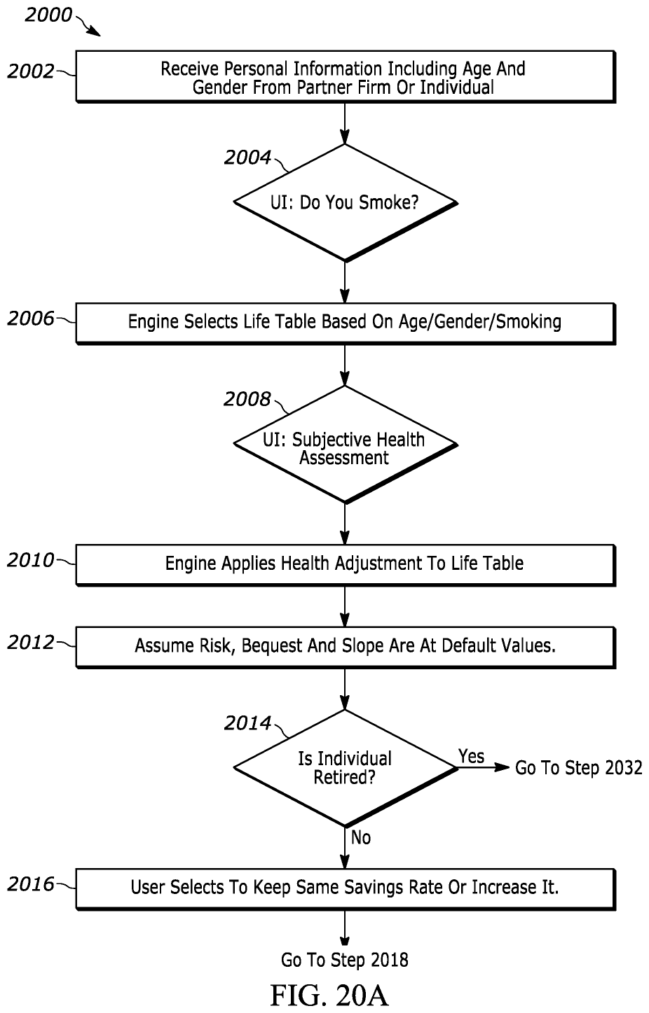

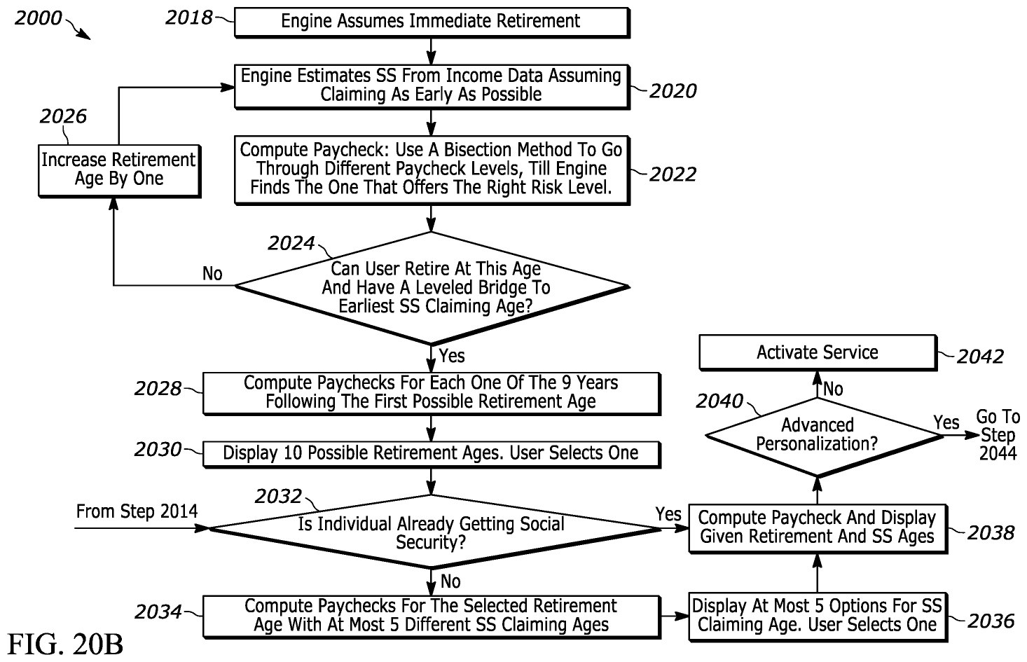

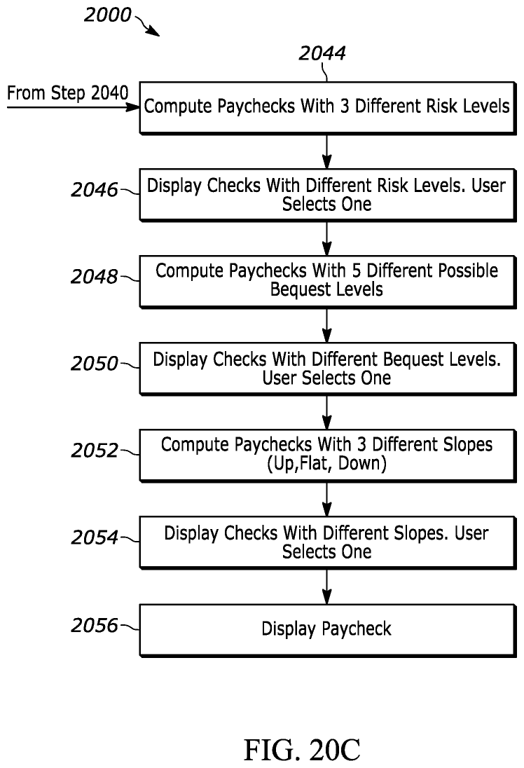

FIGS. 20A, 20B and 20C are a flow diagram 2000 illustrating operation of one example of the present invention. The flow diagram will be discussed with reference to the accompanying user interfaces in FIGS. 2-19.

As an initial step, the income personalization system 102 may request and receive personal background information about the user. The background information component 120 of the income personalization system 102 may request and/or receive the background information about the user or potential user of the income personalization system 102. (Step 2002). A request may be sent to a financial services provider system 108 that may provide background information about one or more people that are potential users of the retirement income personalization system. For example, if the financial services provider administers a retirement savings program, such as a 401(k), the financial services provider system may provide background information about one or more of the retirement plan participants to the income personalization system. The request may also be sent to a user that then responds and provides background information.

The user background information that may be requested and received by the system may include information about the user, including, but not limited to, the user's name, gender, birthdate, current income, current savings rate and current retirement account balance and investment portfolio. Background information may also include the participant's contact information, such as email address and home or work address. The income personalization system may store the background information in one or more data storage devices 106.

The system may send a request to the user device to invite them to use the system 102. The request may be an email to the user. The request may also be presented in a user interface sent to the user's device, such as the user interface 200 shown in FIG. 2.

Next, the system 102 may request health information to be used for personalized longevity modeling, such as whether the user is a smoker (Step 2004). This information be requested by the system in a user interface 600 shown in FIG. 6.

Next, the financial engine 126 may select a life table to use for calculations for the user based on among other things, the user's age, gender and health, e.g., whether they are a smoker. (Step 2006). Other information that may be used to select a life table include the user's geographic location, income and educational attainment.

Next, the system may generate and send a user interface requesting additional information to be used for personalized longevity modeling, such as the user's subjective health assessment (Step 2008). This information be requested by the system's personalization component 124 by sending a user interface 700 shown in FIG. 7 to a user device 104.

The financial engine 126 may then apply the subjective health assessment to the life table (Step 2010).

Next, the financial engine may set certain default values for making initial calculations for an income plan (Step 2012). For example, the engine may set default values for the amount of risk, the amount of a bequest and the user's spending slope.

Then, the financial engine may determine whether the user is retired (Step 2014). If the user is not retired, the engine moves to Step 2016 to obtain additional information from the user. If the user is retired, the system moves to Step 2032.

At Step 2016 the system may send a user interface, such as the one in FIG. 13, to request whether the user wants to increase their current savings rate before moving to Step 2018.

Next, at Step 2018, the financial engine starts to search for the earliest possible retirement age by assuming an immediate retirement date, and then at Step 2020, the financial engine may estimate social security income for the user from income data and uses as a default that the user will claim social security benefits as early as possible given the assumed retirement date (claim at 62 if retirement age is 62 or younger and claim at the retirement age if the retirement age is greater than 62).

Then, at Step 2022, the financial engine may compute an initial paycheck or income plan using common financial techniques. For example, the financial engine may use a bisection method to check different spending plans until it finds one that offers the appropriate risk level.

Next, at Step 2024, the financial engine may then check the see if the user can retire at the assumed age (including a leveled bridge to earliest social security claiming age.) If not, at step 2026, the system will increase by one the age at which it assumes the user can first retire and go back to Step 2020 and recompute an initial paycheck or income plan.

If the engine determines that the there is a viable retirement plan for the assumed retirement age (including a leveled bridge until claiming social security if needed), then it found the earliest possible retirement age and it moves to Step 2028 in order to compute the plan for the 10 earliest possible retirement ages.

At Step 2028, the financial engine calculates paychecks for the user for each of the nine (9) years following the first possible retirement age.

At Step 2030, the income plan or paychecks for the ten (10) possible retirement ages may be presented to the user for personalization. The information can be included in a user interface, such as the one described above in FIG. 10, and sent to the user for selection by the user. The interface may be sent to the user's device 104 by the personalization component 124.

At Step 2032 (whether coming from Step 2014 or Step 2030), the engine determines if the user is already collecting Social Security benefits. If so, the system moves to Step 2038. If not, the system moves to Step 2034.

At Step 2034, the financial engine calculates paychecks for the user given the retirement age they selected for up to five (5) possible ages for first claiming social security benefits.

Next, at Step 2036, interfaces that display the income plan or paychecks for up to five (5) different ages for claiming social security benefits from Step 2034 may be sent to a user device for selection. The information can be included in a user interface, such as the one described above in FIG. 11, for selection by the user.

At Step 2038, (whether coming from Step 2014 or Step 2036) interfaces that display a computed income plan based on the user's selections may be sent to a user device for display, along with the user's retirement age and the user's Social Security claiming age.

Next at Step 2040, the financial engine may determine if advanced personalized in offered or requested. If advanced personalization is not offered or requested, the system may send an interface with information about the retirement income plan or paychecks based on the personalization provided to a user device for display (Step 2042).

If advanced personalization is offered or requested, the financial engine may then compute a spending plan or paychecks for three (3) different risk levels (Step 2044) and the system may send them to a user device for display and selection by the user (Step 2046). The different paychecks may be displayed to a user for selection in a user interface, such as the one described above in FIG. 12.

After the user makes a selection of risk level, the financial engine may compute a spending plan or paychecks for up to five (5) different bequest levels (Step 2048) and the system may send them to a user device for display and selection by the user (Step 2050). The five (5) options may be displayed to a user for selection in a user interface, such as the one described above in FIG. 14.

After the user makes a selection of a bequest level (Step 2050), the financial engine may compute a spending plan or paychecks for three (3) different spending slopes: upward sloping, flat or downward sloping (Step 2052) and the system may send them to a user device for display and selection by the user (Step 2054). The spending slope options may be displayed to a user for selection in a user interface, such as the one described above in FIG. 15.

The financial engine may then compute the spending plan or paycheck associated with the user's selected spending slope and the system may send the plan to a user device for display (Step 2056). The plan may be displayed to a user in one or more user interfaces, such as the ones described above in FIGS. 18 and 19.

Note that other steps may be implemented, such as steps to allow for personalization shown in additional user interfaces described above, such as for personalized holiday spending (FIG. 16) and travel spending (FIG. 17), as well as for increased savings (FIG. 13). In addition, some steps and interfaces described above may not be used and the system may not request all the information in the example above.

Also, the personalization and associated calculation steps may be performed in different orders than presented in the example above.

In order to come up with a personalized income plan, the financial engine component 126 may take the following inputs into account when making calculations of payment plans and payment plan options:

User's current investment portfolio
Social security and other income in retirement (The financial engine can estimate the social security benefit based on last salary and claiming age, following the SSA online calculator methodology)
User's preferences, such as spending more earlier or leaving a minimal bequest
Probability of a user outliving their money, which is the risk measure used for fixed paycheck plans

The engine may also be fed the following assumptions from a financial services provider or other sources:

Mortality table (currently, using the latest period life table (2019) from SSA)
Personalized mortality adjustments (based on smoking, subjective health assessment and geographic location).
Capital market assumptions (Two versions based on 5 or 14 indexes representing asset classes). The assumptions include means, standard deviations and correlation matrix for the indexes. The engine supports a set of target-date retirement funds as well and requires assumptions about their composition and glidepath.

To find a payment or retirement account drawdown plan that suits the input requests, the engine iterates through different contender plans and computes the probability of the individual outliving the portfolio given each plan. It does so until it finds a suitable drawdown plan. The algorithm for finding the plan may be based on Brent's Method, an advanced bisection method. It starts by testing a plan with no drawdown and a plan with maximum drawdown and bisects the space until it finds the one with the correct probability of failure. The engine is currently tuned to arrive at a precision of one decimal point of a percentage. It can be tuned to arrive at a closer probability of failure. The engine computes the probability of outliving the portfolio for each contender plan using a Monte Carlo simulation.

The main component of the engine is a Monte Carlo simulation. Its outcomes are:

Probability of running out of money (not including social security) before dying
Distribution of bequest at every age and at the age of death

The Simulator goes through the following steps for each contender plan:

Take as an input the income plan, i.e., a flat consumption profile or a sloping glidepath (amounts are assumed to be real).

For individuals not yet retired, simulate the balance available at time of retirement using current balance, savings, and investment options until retirement.
Consider the asset allocation that was mapped in pre-processing from the actual holdings to weights on 5 or 14 asset classes/indexes. Generate geometric Brownian motion for each of the assets using the mean, standard deviation and correlations among these asset classes. (The returns for the asset classes can be pre-computed and stored to save time). In addition to the core assets, a set of retirement date funds are also implemented in the code. They are based on industry standard glide paths.
Simulate N (=10000 currently) paths of portfolio returns, portfolio balances and annual drawdowns till the maximum age (currently 110)
Read life expectancy tables for male/female, smoking/non-smoking and adjust them to the health level.
Each simulation path tracks the performance of the assets over time, allowing for consumption according to plan. When funds are not available for consumption from assets according to plan, all available assets are consumed and the consumption from assets is set to zero for the next period and is never resumed.
Spending is given as a flat number or a glide path. Social Security and other guaranteed sources, such as pension income, are added and therefore serve as a lower limit. Annual spending is generated from:
   1. Social Security and any other pension or annuity payments
   2. The indicated amount in the plan if available from assets or a portion thereof if not available
Use expected inflation in current version to inflate the paychecks through time. Simulated inflation paths will be used in later versions and will include asset correlations with inflation as well.
To figure out the probability of the portfolio running out before year of death, one of the three following implementations is used (all have been implemented in different versions):
   1. Use the adjusted life table to create an “age of death” distribution based on the current age of the individual. For example, if current age is 65, what is the probability of dying at 66? 67? etc. Then simulate age of death N times from this distribution, match to the N portfolio paths and for each path compare the year of portfolio hitting zero to the age of death.
   2. Find the portfolio non-survival probabilities for every age (i.e., what is the probability that the portfolio will be depleted at a given age). Average these probabilities using the “age of death” distribution from part 1 as weights.
   3. Use the life table to create the survival probabilities of living beyond a certain age. For example, if current age is 65, what is the probability of living longer than 66? 67? etc. The system will find the distribution of portfolio “age of death”, (i.e., what is the probability of every age to be the first time the portfolio is depleted). Average the survival probabilities using the “age of portfolio death” as weights.

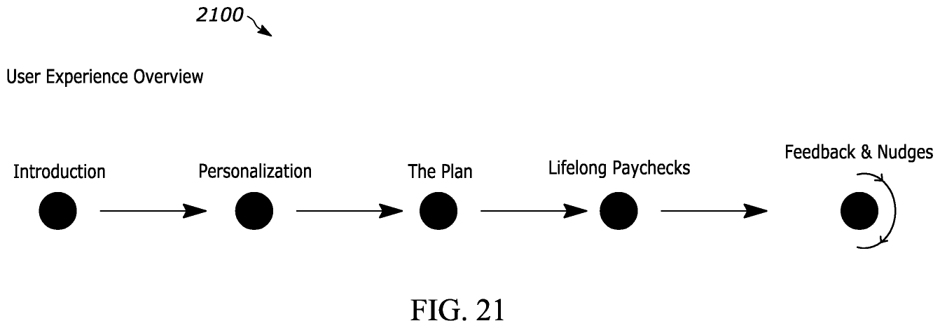

FIG. 21 illustrates, generally, the steps above as well as other steps that can be implemented by the system and method described herein. For example, the system will first introduce the user to the system, will gather information and personalized the retirement income plan and will create the retirement income plan based on the information provided by the user. In addition, the system may provide information to the financial services provider to instruct it to provide the lifelong paychecks to the user in accordance with the plan. The system may also provide the user with feedback and reminders or “nudges” to help the user stay on track with the retirement income plan.

In a first aspect, a computer-implemented method for generation of personalized income plan for a user, comprising: obtaining, by a processor, background information about the user; storing the background information in a computer memory; obtaining, by a processor, longevity information from the user via a user interface; storing the longevity information in a computer memory; determining, by a processor, an initial income plan for a user based on the background information and longevity information; determining, by a processor, one or more alternative income plans based on one or more personalized retirement plan options; presenting to a user, via a user interface that implements a behavioral economics technique, the initial income plan and one or more alternative income plans, as choices for selection by the user of one of the income plans; storing the user's selected income plan in a computer memory; and displaying a message, via a user interface, based on the user's selected income plan.

In a second aspect, the computer-implemented method for generation of personalized income plan for a user of aspect 1, further comprises the step of presenting to a user, via a second user interface that implements a behavioral economics technique, the income plan and one or more alternative updated income plans, as additional choices for selection by the user of one of the income plans as an updated income plan; and storing the user's selected updated income plan in a computer memory.

In a third aspect, the computer-implemented method of any of aspects 1 and 2, wherein the user interface presents the user with choices of income plans based on different retirement dates.

In a fourth aspect, the computer-implemented method of any of aspects 1-3, wherein the user interface presents the user with choices of income plans based on different dates to begin collecting social security benefits.

In a fifth aspect, the computer-implemented method of any of aspects 1-4, wherein the user interface presents the user with choices of income plans based on different levels of risk of outliving retirement savings.

In a sixth aspect, the computer-implemented method of any of aspects 1-5, wherein the user interface presents the user with choices of income plans based on different amounts the user wants to bequeath after their death.

In a seventh aspect, the computer-implemented method of any of aspects 1-6, wherein the user interface presents the user with choices of income plans with different spending slopes.

In an eight aspect, the computer-implemented method of any of aspects 1-7 wherein the user interface presents the user with choices of different income plans with different holiday spending allowances.

In a ninth aspect, the computer-implemented method of any of aspects 1-8, wherein the user interface presents the user with choices of different income plans with different travel spending allowances.

In a tenth aspect, the computer-implemented method of any of aspects 1-7, wherein the behavioral economics technique implemented by the user interface to present choices to the user is the technique of middle bias.

In an eleventh aspect, the computer-implemented method of any of aspects 1-7, wherein the behavioral economics technique implemented by the user interface to present choices to the user is the technique of infographics.

In a twelfth aspect, the computer-implemented method of any of aspects 1-7, wherein the behavioral economics technique implemented by the user interface to present choices to the user is the technique of extreme bias.

In a thirteenth aspect, the computer-implemented method of any of aspects 1-7, wherein the user interface presents choices to the user by presenting informed tradeoffs.

In a fourteenth aspect, a personalized income plan determination system, comprising a plurality of first data storage devices maintaining information about a user, including background information about the user; a financial engine computing device in communication with the first plurality of data storage devices, the financial engine computing device operative to calculate retirement payment plan options for a user based on a user's choices; and; a personalization computing device in communication with the financial engine for creating and transmitting one or more user interfaces that implement behavioral economics techniques to a user device to present retirement plan options as informed tradeoffs to the user and to allow the user to make a selection of retirement income plan options.

In a fifteenth aspect, the system of aspect 14 further comprising a background information device for obtaining the background information about a user.

In a sixteenth aspect, the system of aspect 14 wherein the user interface implements the behavioral economics technique of middle bias.

In a seventeenth aspect, the system of aspect 14 wherein the user interface implements the behavioral economics technique of infographics

In an eighteenth aspect, the system of aspect 14 wherein the user interface implements the behavioral economics technique of extreme bias.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The invention claimed is:

1. A computer-implemented method for generation of personalized income plan for a user, comprising the steps of:
obtaining, by a processor, background information about the user;
storing the background information in a computer memory;
obtaining, by a processor, longevity information from the user via a user interface;
storing the longevity information in a computer memory;
determining, by a processor, an initial income plan for a user based on the background information and longevity information;
determining, by a processor, one or more alternative income plans based on one or more personalized retirement plan options;
presenting to a user, via a user interface that implements a behavioral economics technique, the initial income plan and one or more alternative income plans, as choices for selection by the user of one of the income plans;
storing the user's selected income plan in a computer memory; and
displaying a message, via a user interface, based on the user's selected income plan.

2. A computer-implemented method for generation of personalized income plan for a user of claim 1, further comprising the steps of:
presenting to a user, via a second user interface that implements a behavioral economics technique, the income plan and one or more alternative updated income plans, as additional choices for selection by the user of one of the income plans as an updated income plan; and,
storing the user's selected updated income plan in a computer memory.

3. The computer-implemented method of claim 1 wherein the user interface presents the user with choices of income plans based on different retirement dates.

4. The computer-implemented method of claim 1 wherein the user interface presents the user with choices of income plans based on different dates to begin collecting social security benefits.

5. The computer-implemented method of claim 1 wherein the user interface presents the user with choices of income plans based on different levels of risk of outliving retirement savings.

6. The computer-implemented method of claim 1 wherein the user interface presents the user with choices of income plans based on different amounts the user wants to bequeath after their death.

7. The computer-implemented method of claim 1 wherein the user interface presents the user with choices of income plans with different spending slopes.

8. The computer-implemented method of claim 1 wherein the user interface presents the user with choices of different income plans with different holiday spending allowances.

9. The computer-implemented method of claim 1 wherein the user interface presents the user with choices of different income plans with different travel spending allowances.

10. The computer-implemented method of claim 7 wherein the behavioral economics technique implemented by the user interface to present choices to the user is the technique of middle bias.

11. The computer-implemented method of claim 7 wherein the behavioral economics technique implemented by the user interface to present choices to the user is the technique of infographics

12. The computer-implemented method of claim 7 wherein the behavioral economics technique implemented by the user interface to present choices to the user is the technique of extreme bias.

13. The computer-implemented method of claim 7 wherein the user interface presents choices to the user as informed tradeoffs.

14. A personalized income plan determination system, comprising:
a plurality of first data storage devices maintaining information about a user, including background information about the user;
a financial engine computing device in communication with the first plurality of data storage devices, the financial engine computing device operative to calculate retirement payment plan options for a user based on a user's choices; and;
a personalization computing device in communication with the financial engine for creating and transmitting one or more user interfaces that implement behavioral economics techniques to a user device to present retirement plan options as informed tradeoffs to the user and to allow the user to make a selection of the presented retirement income plan options.

15. The personalized income plan determination system of claim 14 further comprising:
a background information device for obtaining the background information about a user.

16. The personalized income plan determination system of claim 14 wherein the user interface implements the behavioral economics technique of middle bias.

17. The personalized income plan determination system of claim 14 wherein the user interface implements the behavioral economics technique of infographics

18. The personalized income plan determination system of claim 14 wherein the user interface implements the behavioral economics technique of extreme bias.
